(19) United States
(12) Patent Application Publication
(10) Pub. No.: US 2008/0291919 A1
(43) Pub. Date: Nov. 27, 2008

(54) Traffic Distribution and Bandwidth Management for Link Aggregation

(75) Inventors: Linda Dunbar, Plano, TX (US); Robert Sultan, Somers, NY (US); Lucy Yong, Tulsa, OK (US)

Correspondence Address: CONLEY ROSE, P.C., 5601 GRANITE PARKWAY, SUITE 750, PLANO, TX, 75024, US

(73) Assignee: FUTUREWEI TECHNOLOGIES, INC., Plano, TX (US)

(21) Appl. No.: 12/103,841

(22) Filed: Apr. 16, 2008

Related U.S. Application Data
(60) Provisional application No. 60/940,334, filed on May 25, 2007.
(60) Provisional application No. 61/036,134, filed on Mar. 13, 2008.

(51) Int. Cl. H04L 12/56

(52) U.S. Cl. 370/395.3

(57) ABSTRACT

An apparatus comprising a plurality of ingress ports, a routing logic coupled to the ingress ports, and a plurality of egress ports coupled to the routing logic, wherein the routing logic is configured to transport a plurality of data frames associated with a plurality of data flows from the ingress ports to the egress ports, and wherein the apparatus associates at least some of the data flows with a bandwidth. Included is a network component configured to implement a method comprising distributing a plurality of data flows to a plurality of links in a link aggregation group (LAG) using bandwidth information associated with the data flows.

### CROSS-REFERENCE TO RELATED APPLICATIONS

The present application claims priority to U.S. Provisional Patent Application Ser. No. 60/940,334, filed May 25, 2007 by Dunbar et al., and entitled “Traffic Distribution and Bandwidth Management for Link Aggregation”, and U.S. Provisional Patent Application Ser. No. 61/036,134, filed Mar. 13, 2008 by Dunbar et al., and entitled “Techniques to Guarantee Traffic-Engineered Traffic Added to Existing Networks”, which are incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Modem communication and data networks are comprised of nodes that transport data through the network. The nodes may include routers, switches, bridges, or combinations thereof that transport the individual data packets or frames through the network. Some networks may offer data services by forwarding data frames from one node to another node across the network without using pre-configured routes or bandwidth reservation on intermediate nodes. Other networks may forward the data frames from one node to another node across the network along pre-configured routes with each node along the route reserving bandwidth for the data frames, which is referred to as traffic engineered (TE) data services.

Some mixed or hybrid networks may transport both TE and non-TE data services with and without using pre-configured routes or bandwidth reservation, respectively. For instance, some Ethernet networks can offer both TE and non-TE data services using virtual local area network (VLAN) partitioning. As such, one set of VLANs may be used for transporting the TE data services and another set of VLANs may be used for transporting the non-TE data services. The Ethernet network may distribute and forward the TE and non-TE data frames from one node to another node over a plurality of bundled or aggregated links, as opposed to a single link, to increase communications bandwidth between the nodes. In addition, the Ethernet network may transport the TE data services with higher priority than the non-TE data services. As such, the TE data frames may be assigned or provisioned higher priority classes than non-TE data frames before distributing and transporting the data frames over the aggregated links.

However, since the TE and non-TE data services are transported with the option of using the VLANs and without bandwidth information, the TE and non-TE data frames are distributed and transported with no bandwidth consideration. Hence, some links may be used to transport data services at higher bandwidth or rates than other links, which may result in insufficient use of the aggregated links' total bandwidth, cause excessive or unacceptable data losses when some links fail, or both. Furthermore, when all or most of the available priority classes in the network are initially provisioned to non-TE data frames, no or insufficient high priority classes may be available for provisioning any subsequent TE data frames. Thus, distributing and transporting the TE and non-TE data frames requires reassigning the high and low priority classes.

### SUMMARY

In one embodiment, the disclosure includes an apparatus comprising a plurality of ingress ports, a routing logic coupled to the ingress ports, and a plurality of egress ports coupled to the routing logic, wherein the routing logic is configured to transport a plurality of data frames associated with a plurality of data flows from the ingress ports to the egress ports, and wherein the apparatus associates at least some of the data flows with a bandwidth.

In another embodiment, the disclosure includes a network component configured to implement a method comprising distributing a plurality of data flows to a plurality of links in a link aggregation group (LAG) using bandwidth information associated with the data flows.

In a third embodiment, the disclosure includes a network component comprising a processor configured to implement a method comprising transporting a plurality of data flows through a LAG comprising a plurality of links, and disabling at least one data flow when a fault occurs in one of the links, wherein all the frames associated with the disabled data flow are dropped.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a schematic diagram of an embodiment of a data transport system with link aggregation.

FIG. 2 is an illustration of an embodiment of a traffic flow table.

FIG. 3 is a flowchart of one embodiment of a TE Traffic Distribution Method.

FIG. 4 is a flowchart of one embodiment of a non-TE Traffic Distribution Method.

FIG. 5 is an illustration of an embodiment of a priority class mapping table.

FIG. 6 is a flowchart of one embodiment of a Traffic Redistribution Method.

FIG. 7 is a schematic diagram of an embodiment of a general-purpose network component.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein is a system and method for distributing TE traffic over aggregated links based on the bandwidth allocated to the TE traffic and the aggregated links' available bandwidth capacities. Specifically, the TE traffic may be distributed about evenly over the aggregated links such that each link may be used to transport the data frames corresponding to at least one TE traffic stream at about equal bandwidth or a bandwidth comparable with the other links. The non-TE traffic may have lower priority than the TE traffic, and may hence be distributed on any remaining bandwidth based on the non-TE bandwidth requirements or other criteria. To maintain priority of the TE traffic over the non-TE traffic, the TE traffic may be assigned to separate traffic classes than the non-TE classes. The TE traffic classes may then be mapped to higher priorities than the non-TE traffic classes. Moreover, when any of the aggregated links fails, the TE traffic over the failed link may be redistributed over the remaining aggregated links. The redistributed TE traffic, which has a higher priority than the non-TE traffic, may cause the non-TE traffic to be dropped due to insufficient bandwidth on the remaining aggregated links.

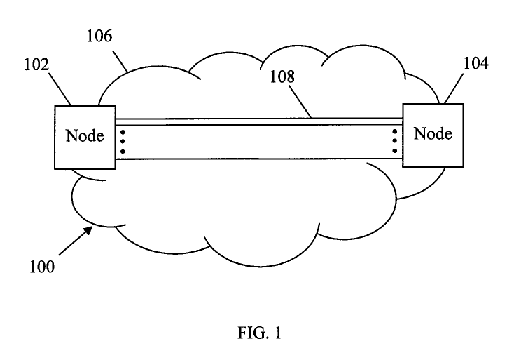

FIG. 1 illustrates one embodiment of a system 100 that transports data from one location to another location using link aggregation. The system 100 comprises a first node 102, a second node 104, a network 106, and a plurality of links 108. It should be recognized that while FIG. 1 illustrates two nodes 102 and 104, the network 106 may comprise more than two nodes, where at least one pair of nodes may be connected via a plurality of links similar to the links 108. The nodes 102 and 104 may exchange data with each other via at least one of the individual links 108. The nodes 102 and 104 may also exchange data via at least one aggregated link that comprises a plurality of logically combined links 108.

The nodes 102, 104 may be any devices, components, or networks that may generate data, receive data, and/or forward the received data to proper output port. The nodes 102, 104 may also forward the received data frames of data streams onto other nodes along pre-configured paths that may exist in the network 106 or any external network coupled to the network 106. The nodes 102, 104 may be configured with a plurality of ingress ports that receive data, routing logic that switches or routes the data, and a plurality of egress ports that transmit the data. The nodes 102, 104 may also contain a plurality of buffers that temporarily store the data during periods of data congestion. For example, the nodes 102, 104 may be routers, switches, or bridges, including backbone core bridges (BCBs), backbone edge bridges (BEBs), provider core bridges (PCBs), and provider edge bridges (PEBs). Alternatively, the nodes 102, 104 may be fixed or mobile user-oriented devices, such as data servers, desktop computers, notebook computers, personal digital assistants (PDAs), or cellular telephones. In a specific embodiment, the nodes 102, 104 may be devices similar to those described in U.S. patent application Ser. No. 11/691,557, filed Mar. 27, 2007 by Dunbar et al., and entitled “System for Providing Both Traditional and Traffic Engineering Enabled Services,” which is incorporated herein by reference as if reproduced in its entirety.

The network 106 may be any communication system that may be used to transport data between nodes 102, 104. For example, the network 106 may be a wire-line network or an optical network, including backbone, provider, and access networks. Such networks typically implement Synchronous Optical Networking (SONET), Synchronous Digital Hierarchy (SDH), Ethernet, Internet Protocol (IP), Asynchronous Transfer Mode (ATM), or other protocols. Alternatively, the network 106 may be a wireless network, such as a Worldwide Interoperability for Microwave Access (WiMAX), cellular, or one of the Institute for Electrical and Electronic Engineers (IEEE) 802.11 networks. The network 106 may transport traffic between the nodes 102 and 104 using VLANs, as described in IEEE 802.1Q. The traffic may comprise connectionless or switched traffic, also referred to as service instances or non-TE traffic, as described in IEEE 802.1ah. The traffic may also comprise connection-oriented traffic, also referred to as Provider Backbone Bridge-Traffic Engineering (PBB-TE) traffic or TE traffic, as described in IEEE 802.1Qay.

In an embodiment, the links 108 may be any devices or media that transport data between a plurality of nodes. Specifically, the links 108 may be physical (e.g. electrical or optical), virtual, and/or wireless connections that traverse at least part of the network 106. Although the links 108 may contain one or more intermediate nodes, the links 108 may also be a plurality of physical links that directly connect to the ports on each of the nodes 102, 104. The individual nodes 102, 104 and links 108 may have different properties, such as physical structure, capacity, transmission speed, and so forth.

A LAG may be the combination of a plurality of links into a single logical link. For example, two links 108 may be grouped together to form one aggregated link between nodes 102 and 104. When individual links 108 are aggregated, the bandwidth associated with the links 108 may also aggregated. For example, if two links 108 each have a bandwidth of about one gigabit per second (Gbps) and are aggregated together, then the aggregated link may have a bandwidth of about two Gbps. In embodiments, the link aggregation may conform to IEEE 802.3ad, which is a standard for link aggregation in Ethernet networks and is incorporated herein by reference as if reproduced in its entirety.

The aggregated links may allow bandwidth to be increased with greater granularity than individual links. Specifically, technology upgrades typically result in bandwidth increases of an order of magnitude. For example, a first generation link may provide a data rate of about one Gbps, while a second-generation link may provide a data rate of about ten Gbps. If a first link 108 is a first generation link and needs to be upgraded to about three Gbps, then upgrading the first link to the second generation may produce about seven Gbps of unused bandwidth. Instead, two additional first generation links 108 may be aggregated with the first link to provide the required bandwidth. As such, link aggregation allows bandwidth to be upgraded incrementally, and may be more cost effective than other upgrade solutions.

Link aggregation may also provide increased resilience by allowing multiple operational states. A single link may be described as being in an operational state or “up” when the single link operates at complete bandwidth capacity. Likewise, the single link may be described as being in a non-operational state or “down” when the single link is disconnected such that it does not have any bandwidth capacity or operates at partial bandwidth capacity. Furthermore, if an aggregated link includes two links and each of the links has an equal bandwidth capacity, then the aggregated link may be up where all of the links are up, half up where one link is up and the other link is down, or down where all of the links are down.

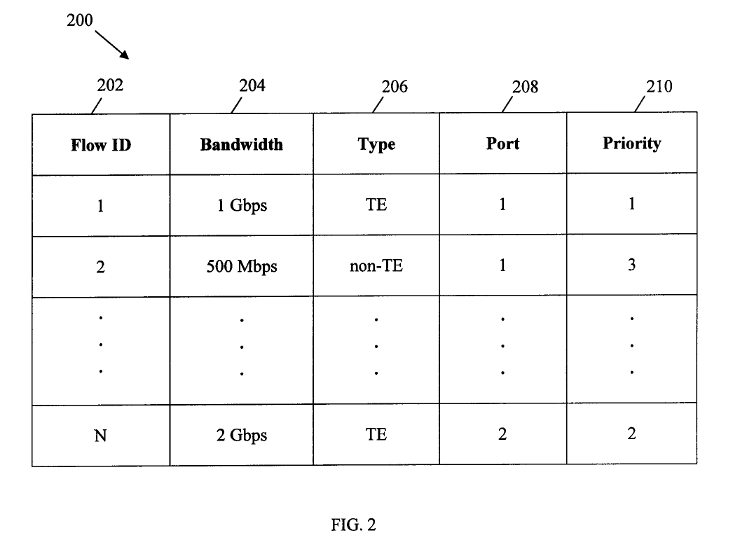

FIG. 2 shows a traffic flow table 200 that illustrates an embodiment of traffic flow information that may be used in a network, such as the network described herein. The traffic flow table 200 may be stored at some of the network nodes or at a management entity. Specifically, the traffic flow table 200 may be used to store the information needed to maintain the individual traffic flows over the network links. For instance, each traffic flow may be assigned a flow identifier (ID) that distinguishes the flow from other flows in the network, as indicated in column 202.

The traffic flow information may also comprise the bandwidth required or allocated for each traffic flow, as indicated in column 204. For example, the traffic flow bandwidth may be associated with each IEEE 802.1ah service instance or IEEE 802.1 PBB-TE path in the network. In some embodiments, the traffic flow bandwidth may be associated with each VLAN or VLAN identifier (VID) that may be used for transporting the traffic in the network. Alternatively, the traffic flow bandwidth may be associated with the VID and the source address (SA) of each traffic flow, the VID and the destination address (DA) of each traffic flow, or the combined VID, SA, and DA of each traffic flow. Alternatively, the traffic flow bandwidths for the various traffic flows may be associated with various combinations of the above identifiers.

Additionally, the traffic flow information may comprise the type of each traffic flow, such as TE or non-TE traffic types, as indicated in column 206. In some embodiments, the traffic flow information may comprise the port, or the link, allocated for each traffic flow, as indicated in column 208. The traffic flow information may also comprise the priority assigned to each traffic flow, as indicated in column 210 and described in further detail below.

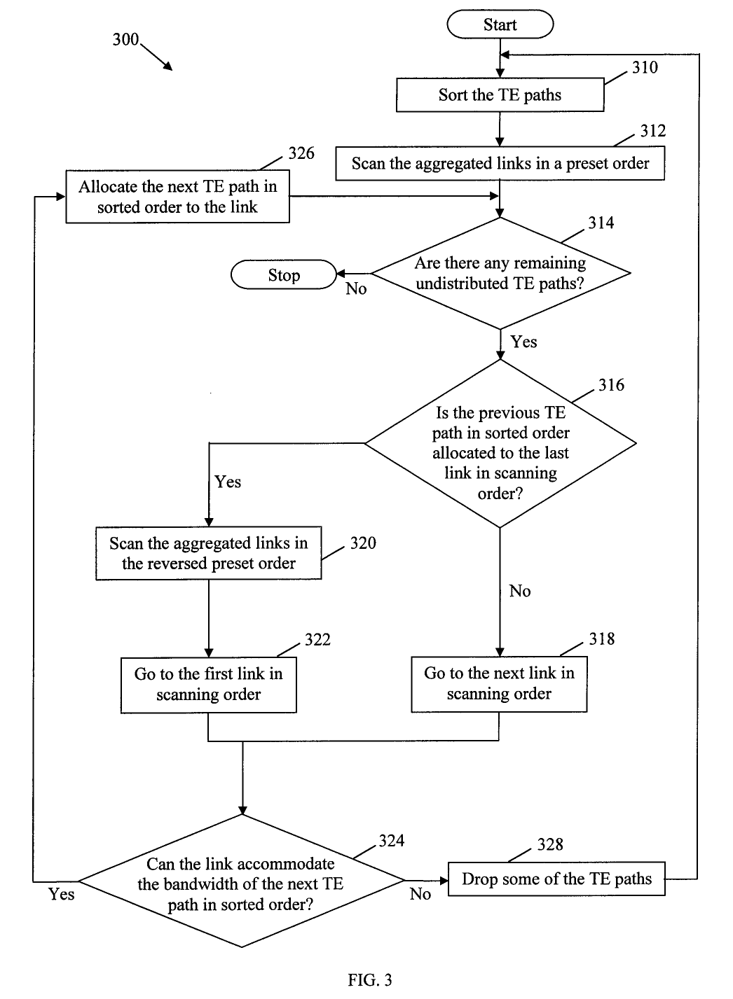

FIG. 3 illustrates one embodiment of a TE traffic distribution method 300, which may be implemented to distribute the individual TE traffic flows over the aggregated links of a network node based on bandwidth information. Specifically, the TE traffic flows or paths may be first allocated over the individual links at about equal or comparable bandwidths and then distributed accordingly.

At block 310, the method 300 may sort the TE paths based on the bandwidth requirements of the TE paths. For instance, the method 300 may sort the TE paths in ascending order, where each TE path may precede another TE path with larger bandwidth requirement in a sorting queue. In an embodiment, the TE paths may be sorted by assigning sequential identifiers or labels to the TE paths, such that the TE paths with smaller bandwidth requirements are assigned smaller label values. Alternatively, the TE paths may be sorted in descending order, where each TE path may precede another TE path with smaller bandwidth requirement in the sorting queue. The TE path bandwidth requirements may be obtained from the traffic flow table. Alternatively, the TE path bandwidth requirements may be received or included in at least one of the frames in the TE paths or may be specified by a management or control plane, such as a network management system.

At block 312, the method 300 may specify the order for scanning the aggregated links, such that each link may be examined in a preset order for availability to accommodate one of the TE paths. For instance, the links may be considered in a preset order that matches the port or interface number in connection with each link. As such, the first link to be considered may be connected to the port or interface with the smallest number and the last link to be considered may be connected to the port or interface with the largest number. Alternatively, the links may be considered based on the links' bandwidth capacities, for example, where the links with larger bandwidth capacities may be considered first.

At block 314, the method 300 may verify whether any of the TE paths remain undistributed or unallocated to one of the aggregated links. For instance, the method 300 may verify whether any TE traffic flow IDs in the traffic flow table are not associated with a port or link. The method 300 may proceed to block 316 when the condition at block 314 is met, i.e. when at least one TE path remains unallocated to a link. Otherwise, when all the TE paths are distributed over the aggregated links, the method 300 may end.

At block 316, the method 300 may verify whether the previous TE path in the sorted queue is allocated to the last link in the preset link scanning order. The method 300 may proceed to block 318 when the condition at block 316 is not met. Otherwise, when the previous TE path in the sorted queue is allocated to the last link in the preset link scanning order, the method 300 may proceed to block 320.

At block 318, the method 300 may consider the next link in the preset link scanning order for availability to accommodate the next TE path in the sorted queue. The method 300 may then proceed to block 324. Alternatively, at block 320, the method 300 may reset the link scanning order in the reversed direction or order, where the last link in the preset order may be considered first and the first link in the preset order may be considered last to accommodate the next TE path in the sorted queue. Next, the method 300 may proceed to block 322, where the method 300 may consider the first link in the preset link scanning order. Thus, the last considered link in the preset order may again be reconsidered as the first link in the reverse order.

At block 324, the method 300 may verify whether the considered link can accommodate the next TE path's bandwidth requirement. For instance, the method 300 may check whether the link is unoccupied or available bandwidth is smaller than the TE path's bandwidth requirement. The method 300 may proceed to block 326 when the condition at block 324 is met. Otherwise, the method 300 may proceed to block 328 when the condition at block 324 is not met.

At block 326, the method 300 may allocate the next TE path to the link under consideration. In some embodiments, the next TE path may be allocated to the considered link by assigning the link to the TE path or traffic flow in the traffic flow table. When a TE path is allocated to a link, all of the frames associated with the TE path are transported over the link in the same order as received at the node. The method 300 may then return to block 314. Alternatively, at block 328, the method 300 may drop at least the next TE path, at least one of the remaining unallocated TE paths, or all the TE paths including the distributed TE paths, and return to the beginning at block 310. In some embodiments, the method 300 may redistribute all or some of the TE traffic at block 328 as will be described in further detail below.

By reversing the link scanning order when reaching the last link, the method 300 may distribute alternating sequences of TE paths with increasing and decreasing bandwidth requirements over the aggregated links. Consequently, the individual links may be allocated alternating sequences of TE paths with small and large bandwidth requirements resulting in a substantially even or balanced distribution of the TE paths, in terms of bandwidth requirements, over the aggregated links. Such substantially even or balanced distribution may result in improved link utilization, reduced traffic congestion, or both over some of the individual links. Additionally, since the links may comprise TE paths having similar bandwidths, the traffic losses may be reduced during partial links failures, since no link accommodates a disproportionately larger amount of TE paths.

The algorithm described in FIG. 3 assumes that all member links within the aggregation group has more available bandwidth than any single TE path. There are other suitable algorithms that may be used to distribute the TE paths to member links of an aggregation group, such as using priority as a basis to distribute traffic, assigning new TE-paths to member links without touching the TE-paths that are already assigned to the member links, or re-assigning existing TE-paths on the member links to optimize overall distributions. It will be appreciated that any such distribution algorithms may also be used for the purposes described herein.

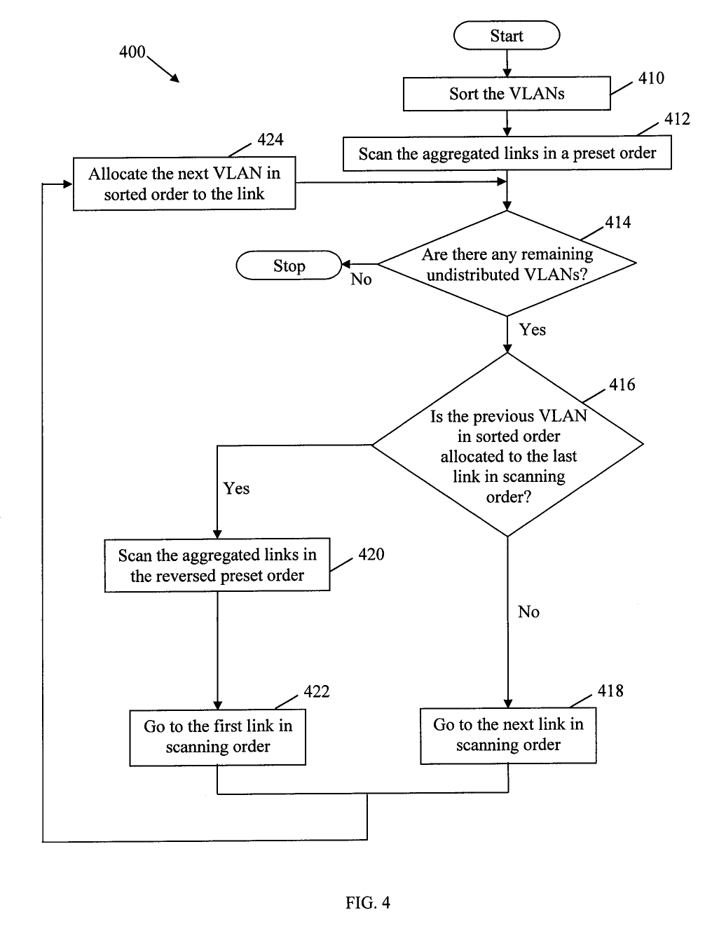

FIG. 4 illustrates an embodiment of a non-TE traffic distribution method 400, which may be implemented to distribute non-TE traffic based on bandwidth information over the aggregated links. Specifically, the VLANs used to transport the non-TE data services or traffic may be allocated to the individual links at about equal or comparable bandwidths. Moreover, the non-TE traffic may be re-assigned with lower priorities than the priority indicated by the frame's priority bits to make all TE traffic have higher priority than non-TE traffic regardless data frames' priority bits setting. Non-TE traffic may be distributed after distributing the TE traffic over the links, for example, after using the TE traffic distribution.

At block 410, the method 400 may sort the VLANs based on the bandwidth requirements of the non-TE data services, which may be obtained from the traffic flow table, the non-TE traffic frames, or the management or control plane. For instance, the method 400 may sort the VLANs in ascending order, where each VLAN may precede another VLAN with larger bandwidth requirement in a sorting queue. Alternatively, the VLANs may be sorted in descending or, where each VLAN may precede another VLAN with smaller bandwidth requirement.

At block 412, the method 400 may specify a preset order for scanning the aggregated links for availability to accommodate one of the VLANs. For instance, the links may be considered in ascending or descending order based on the port number in connection with each link, or based on the links' bandwidth capacities. At block 414, the method 400 may verify whether any of the VLANs remain undistributed or unallocated to one of the aggregated links. In an embodiment, the method 400 may scan the traffic flow table for any non-TE traffic flows that is not assigned to a port or link. The method 400 may proceed to block 416 when the condition at block 414 is met. Otherwise, when all the VLANs are distributed over the aggregated links, the method 400 may end.

At block 416, the method 400 may verify whether the previous VLAN in the sorted queue is allocated to the last link in the preset link scanning order. The method 400 may proceed to block 418 when the condition at block 416 is not met. Otherwise, when the previous VLAN in the sorted queue is allocated to the last link in the preset link scanning order, the method 400 may proceed to block 420.

At block 418, the method 400 may consider the next link in the preset link scanning order for availability to accommodate the next VLAN in the sorted queue. The method 400 may then proceed to block 424. Alternatively, at block 420, the method 400 may reset the link scanning order in the reversed direction or order, where the last link in the preset order may be considered first and the first link in the preset order may be considered last to accommodate the undistributed VLANs in the sorted queue. Next, the method may proceed to block 422, where the method 400 may consider the first link in the preset link scanning order. Thus, the last considered link in the preset order may again be reconsidered as the first link in the reverse order. After either block 418 or block 422, the method 400 may proceed to block 424.

At block 424, the method 400 may allocate the next VLAN to the link under consideration, for example, by assigning the link to the non-TE flow associated with the VLAN. The allocated link may be used to transport the non-TE traffic corresponding to the allocated VLAN when the link's unoccupied or available bandwidth is smaller than the non-TE traffic's bandwidth requirement. Otherwise, the non-TE traffic may be queued or held until enough link bandwidth becomes available to accommodate the non-TE traffic's bandwidth requirement. In addition, when a VLAN is allocated to a link, all the frames associated with the VLAN are transported over the link in the same order as received at the node. The method 400 may then return to block 414. In some embodiments, the method 400 may first verify whether the considered link can accommodate the non-TE traffic's bandwidth requirement, similar to the method 300. If the link's available bandwidth may accommodate the non-TE traffic's bandwidth requirement, the method 400 may then allocate the next VLAN to the link. Otherwise, the method 400 may drop the VLAN from the queue or redistribute the VLANs as will be described in further detail below.

In other embodiments, non-TE traffic may also be distributed without bandwidth information over the aggregated links. In the absence of non-TE traffic bandwidth information, the non-TE traffic may be distributed over the aggregated links using traditional or known distribution algorithms. For instance, the non-TE traffic frames may be distributed over the links based on the assigned traffic priorities. In any case, the TE traffic may be assigned higher priority than the non-TE traffic.

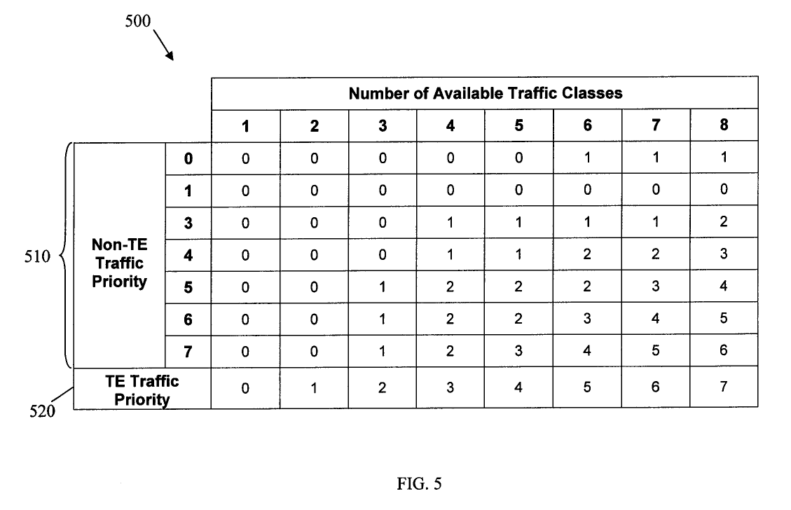

FIG. 5 shows a priority class mapping table 500 that illustrates an embodiment of TE and non-TE traffic priority re-assignments in a hybrid network, where all TE traffic may be re-assigned higher priorities than non-TE traffic at the local bridge/interface. Specifically, the TE traffic may be assigned to some of a plurality of priority queues, which may be established at the node interfaces. The non-TE traffic may hence be re-assigned to the remaining priority queues, even though non-TE traffic data frames' priority bits have same level or even higher setting than TE traffic data frame's priority bits. The TE traffic queues may be assigned higher priorities than the non-TE traffic queues to guarantee that all TE traffic has higher priority over all non-TE traffic. For example, all non-TE traffic may be assigned to seven priority queues out of eight available priority queues, as indicated in rows 510. The TE traffic may then be assigned to the remaining priority queue indicated in row 520, which may have higher priority than the seven priority queues in rows 510.

Moreover, each of the TE and non-TE priority queues may comprise a plurality of traffic classes, which may be in turn assigned to different classes of TE and non-TE traffic, respectively. The traffic classes may designate the type of data services transported in the network, such as packet switched traffic, constant bit rate (CBR) traffic, high quality of service (QoS) traffic, video streaming traffic, voice over internet packet (VoIP) traffic, etc. For example, each one of the seven non-TE priority queues in rows 510 and the eighth TE priority queue in row 520 may comprise eight priority classes, which may be allocated or mapped to different classes of non-TE and TE traffic, respectively.

For each traffic class, the TE traffic in the TE traffic queue may be assigned a higher priority than the non-TE traffic. For example, the TE traffic corresponding to the fifth traffic class may be assigned a higher priority, equal to about four, than the priorities assigned to the non-TE traffic, equal to about one, about two, or about three. In some embodiments, to guarantee a higher priority to TE traffic over non-TE traffic, the TE traffic may be reassigned the non-TE traffic priority, while the non-TE traffic may be reassigned a lower priority. For example, the TE traffic corresponding to the eighth traffic class may be reassigned a non-TE traffic's priority, equal to about seven, while the non-TE traffic may be reassigned a priority equal to about zero. When the TE traffic is transported, the non-TE traffic may be reassigned its original priority.

In another embodiment, the number of the priority queues designated to TE traffic may be proportional to the number of the TE traffic pre-allocated over the aggregated links, while the remaining priority queues may be designated for the non-TE traffic. For example, if the TE traffic to be distributed over the aggregated links comprises about 75 percent of the total links' bandwidth, then about 75 percent of the available priority queues may be used to map the TE traffic classes. The remaining priority queues, at about 25 percent of the total links' bandwidth, may hence be used to map the non-TE traffic classes. In these embodiments, the priority within the data frames is not modified, but instead the different classes and priorities of traffic are merely assigned to different queues and processed according to the methods described herein.

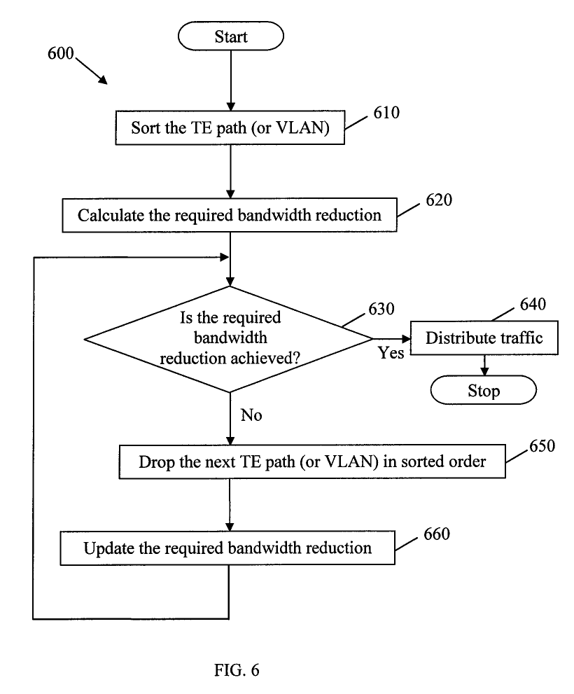

FIG. 6 illustrates an embodiment of a traffic redistribution method 600, which may be implemented to redistribute TE as well as non-TE traffic over the aggregated links. Specifically, some traffic flows may be discarded or dropped based on the traffic assigned priority, in case of insufficient link bandwidth, link failure, or traffic congestion. The traffic flows may be dropped until the available links' bandwidth may be sufficient to accommodate the remaining traffic bandwidth requirements. The remaining traffic may then be distributed over the links using, for example, the TE traffic distribution method followed by the non-TE traffic distribution method.

At block 610, the method 600 may sort the TE traffic as well as any existing non-TE traffic based on the traffic assigned priorities, for example using the priority class mappings in the priority class mapping table. In an embodiment, the TE and non-TE traffic may be sorted by resorting the traffic flows in the traffic flow table based on the individual traffic priorities. Since the TE traffic may be assigned to higher priority queues than the non-TE traffic, all TE traffic classes may precede the non-TE traffic classes in sorting order. For example, all the TE traffic assigned to the traffic classes of the eighth priority queue 520 may be sorted in ascending priority order (higher priority first). The non-TE traffic assigned to the traffic classes of the seven priority queues 510 may then succeed the TE traffic, also in ascending priority order. Alternatively, the traffic may be sorted based on the priorities included in the traffic frames, where the frames corresponding to the TE traffic may comprise higher priorities than the frames corresponding to the non-TE traffic.

At block 620, the method 600 may calculate the reduction in traffic bandwidth required to accommodate the distribution of all traffic over the available links. For instance, the amount of bandwidth reduction may be estimated as the difference between the total traffic bandwidth requirements and the total available links' bandwidth. At block 630, the method 600 may verify whether the traffic bandwidth reduction has been achieved. For instance, the method 600 may verify if the amount of bandwidth reduction has reached about zero, which may indicate that no further traffic bandwidth reduction is needed. The method 600 may proceed to block 640 when the condition at block 630 is met, otherwise the method 600 may proceed to block 650.

At block 640, the method 600 may distribute the remaining traffic over the aggregated links, and the method 600 may then end. For instance, in the case of dropping all non-TE traffic and some TE traffic, the method 600 may distribute the remaining TE traffic using, the TE traffic distribution method. On the other hand, if some non-TE traffic and no TE traffic are dropped, the TE traffic may be first distributed over the aggregated links using, for example, the TE traffic distribution method followed by the remaining non-TE traffic using, for example, the non-TE traffic distribution method.

Alternatively, at block 650, the method 600 may drop at least the traffic flow corresponding to the next traffic in the sorted traffic order. When a traffic flow is dropped, substantially all the frames associated with the traffic flow are dropped. In addition, the traffic flow entries in the traffic flow table, may be deleted, flagged, or assigned a bandwidth at about zero, for example. In some embodiments, the traffic may be dropped based on a drop eligibility bit in the traffic frames. For instance, when the drop eligibility bit is set in one or some frames corresponding to a non-TE traffic flow, all frames corresponding to the non-TE traffic flow may be dropped. The drop eligibility bit may also be set in some TE traffic frames, which correspond to TE traffic flows with lower priorities, to achieve the required bandwidth reduction.

At block 660, the method 600 may recalculate the reduction in traffic bandwidth required after dropping the next traffic in the sorted order. For instance, the amount of bandwidth reduction may be updated by subtracting the dropped traffic bandwidth requirement from the required bandwidth reduction. The method 600 may then return to block 630 to drop more traffic if needed.

In another embodiment, the TE and non-TE traffic initially allocated to one or a plurality of failed links may be redistributed by calculating the traffic bandwidth requirements, verifying if sufficient bandwidth is available at the remaining links, and distributing the TE and non-TE traffic over the remaining links similarly to the method 600. As such, the traffic initially allocated to failed links may be redistributed without substantially redistributing or affecting the transport of the remaining TE traffic. In another embodiment, the TE and non-TE traffic allocated to the failed links may be dropped or discarded with no traffic redistribution.

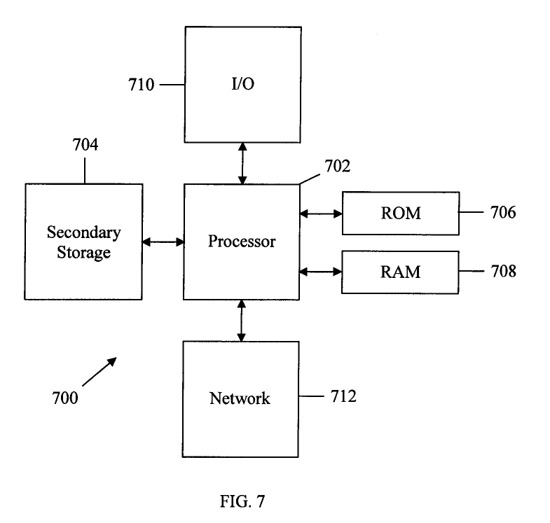

The network components described above may be implemented on any general-purpose network component, such as a computer or network component with sufficient processing power, memory resources, and network throughput capability to handle the necessary workload placed upon it. FIG. 7 illustrates a typical, general-purpose network component suitable for implementing one or more embodiments of a node disclosed herein. The network component 700 includes a processor 702 (which may be referred to as a central processor unit or CPU) that is in communication with memory devices including secondary storage 704, read only memory (ROM) 706, random access memory (RAM) 708, input/output (I/O) devices 710 such as ingress or egress ports, and network connectivity devices 712. The processor may be implemented as one or more CPU chips, or may be part of one or more application specific integrated circuits (ASICs).

The secondary storage 704 is typically comprised of one or more disk drives or tape drives and is used for non-volatile storage of data and as an over-flow data storage device if RAM 708 is not large enough to hold all working data. Secondary storage 704 may be used to store programs that are loaded into RAM 708 when such programs are selected for execution. The ROM 706 is used to store instructions and perhaps data that are read during program execution, or may act as a buffer during periods of data congestion. ROM 706 is a non-volatile memory device that typically has a small memory capacity relative to the larger memory capacity of secondary storage 704. The RAM 708 is used to store volatile data and perhaps to store instructions. Access to both ROM 706 and RAM 708 is typically faster than to secondary storage 704.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. An apparatus comprising:
a plurality of ingress ports;
a routing logic coupled to the ingress ports; and
a plurality of egress ports coupled to the routing logic,
wherein the routing logic is configured to transport a plurality of data frames associated with a plurality of data flows from the ingress ports to the egress ports, and wherein the apparatus associates at least some of the data flows with a bandwidth.

2. The apparatus of claim 1, wherein at least some of the data flows are associated with a bandwidth using a data flow table.

3. The apparatus of claim 1, wherein the data flow table comprises a data flow identifier, a bandwidth, a port, and optionally, a traffic type, a priority, or combinations thereof.

4. The apparatus of claim 1, wherein at least some of the data flows are identified by a virtual local area network identifier (VID), a service instance identifier, a combination of the VID and a destination address (DA), a combination of the VID and a source address (SA), or a combination of the VID, the DA, and the SA.

5. A network component comprising:
a processor configured to implement a method comprising:
distributing a plurality of data flows to a plurality of links in a link aggregation group (LAG) using bandwidth information associated with the data flows.

6. The network component of claim 5, wherein the method further comprises sorting the data flows based on the priority and subsequently sorting the data flows based on the bandwidth information.

7. The network component of claim 6, wherein the data flows comprise traffic-engineered (TE) data flows and non-TE data flows, and wherein the TE data flows are prioritized over the non-TE data flows by being assigned to local traffic classes or queues regardless of any priority indicated in the non-TE data flows.

8. The network component of claim 6, wherein each link accommodates an alternating sequence of the sorted data flows with high and low bandwidth information.

9. The network component of claim 5, wherein the order of each data flow is maintained while being transported within the link to which it is distributed.

10. The network component of claim 5, wherein each data flow is allocated to one link.

11. The network component of claim 5, wherein the data flows are distributed such that the cumulative bandwidth of the data flows transported over each link is about equal or comparable with the other links.

12. A network component configured to implement a method comprising:
transporting a plurality of data flows through a link aggregation group (LAG) comprising a plurality of links; and
disabling at least one data flow when a fault occurs in one of the links, wherein all the frames associated with the disabled data flow are dropped.

13. The network component of claim 12, wherein the data flows are associated with a priority, and wherein the disabled data flow has a lower priority than the remaining data flows.

14. The network component of claim 12, wherein the data flows are associated with a traffic class, and wherein the disabled data flow corresponds to one of the traffic classes.

15. The network component of claim 12, wherein the data flows are associated with a plurality of queues, and wherein the disabled data flow corresponds to at least one of the queues.

16. The network component of claim 12, wherein the method further comprises redistributing any remaining data flows associated with the faulty link to at least one of the remaining links.

17. The network component of claim 16, wherein the remaining data flows associated with the faulty link are redistributed to the remaining links until the remaining links reach their capacity, and then any undistributed remaining data flows associated with the faulty link are dropped.

18. The network component of claim 16, wherein the data flows comprise traffic-engineered (TE) data flows, and wherein the TE data flows transported through the remaining links are unaffected by the disabling or the redistribution.

19. The network component of claim 16, wherein the data flows comprise non-traffic engineered (TE) data flows, and wherein the disabled data flows comprise any non-TE traffic associated with the faulty link and at least some of the non-TE traffic associated with the remaining links.

20. The network component of claim 12, wherein the method further comprises balancing the remaining data flows across the remaining links such that the bandwidth transported through each link is about equal or comparable with the other links.

21. The network component of claim 20, wherein the data flows comprise traffic engineered (TE) data flows, and wherein the balancing is limited to the TE data flows.
